(19) United States
(12) Patent Application Publication
(10) Pub. No.: US 2009/0087279 A1
(43) Pub. Date: Apr. 2, 2009

(54) Quick Connection Device

(75) Inventors: Kevin J. McGinn, Sterling, IL (US); Antonio Luigi Sosi, Rock Falls, IL (US)

Correspondence Address: REINHART BOERNER VAN DEUREN P.C., 2215 PERRYGREEN WAY, ROCKFORD, IL, 61107, US

(73) Assignee: Kevton, LLC, Sterling, IL (US)

(21) Appl. No.: 11/863,803

(22) Filed: Sep. 28, 2007

(51) Int. Cl. F16B 21/00

(52) U.S. Cl. 411/337

(57) ABSTRACT

A quick connection device including a body and a first resilient finger is provided. The first resilient finger extends from the body at a first pivot end and includes a first bolt engagement portion for engaging a threaded bolt. The first resilient finger applies a lateral force in a first direction traverse to an axis of rotation of the threaded bolt by pivoting as the threaded bolt is rotated. In another embodiment, the quick connection device includes a second resilient finger and forms an opening configured such that the threaded bolt may be pushed therethrough. The first and second resilient fingers clamp the threaded bolt when the threaded bolt is rotated.

### FIELD OF THE INVENTION

This invention generally relates to a quick connection device and, more particularly, to a quick connection device for installing an electrical device or devices in an electrical box or ring.

### BACKGROUND OF THE INVENTION

As technology advances, consumers are using more and more electrically-powered and electrically-wired devices. As a result, commercial and residential structures are being designed to include more and more electrical devices (e.g., electrical receptacles, electrical outlets, plug-ins, phone jacks, network cable jacks, etc.). Where a room in a structure may have had only a few electrical devices in the past, such a room may now have numerous different electrical devices. Therefore, electrically-powered and electrically-wired devices may be conveniently electrically coupled (i.e., plugged-in) to an electrical source (e.g., AC or DC source), connected to a network, or charged by the AC source if they include a battery.

When installing electrical devices within a structure, the electrician (or another worker) typically mounts an electrical box (a.k.a., electrical ring, junction box, electrical box cover, etc.) to one of the studs within the structure. With the electrical box suitably supported by the stud, the electrician then appropriately wires the electrical device. With the wiring complete, the electrician next drives a threaded bolt supplied with the electrical device into each of a set of tapped (a.k.a., threaded) apertures in the electrical box using a screwdriver or drill. As such, the electrical device is securely held by the electrical box which is, in turn, supported by the stud.

After the electrical device is wired and supported, a building material such as drywall is fitted around the electrical device. Then, a protective, yet aesthetic, cover is secured over the electrical device to protect and hide the electrical box and the wiring.

Unfortunately, while the above-noted procedure for installing an electrical device is suitable, it takes an electrician a rather substantial amount of time to complete his portion. This is due, at least in part, to the electrician having to completely threadably drive the threaded bolts provided with the electrical device into each of the tapped apertures in the electrical box. For each bolt that must be completely threadably driven in this manner, the cost of having electrical work performed increases. This generally translates into the overall structure costing more to be built or remodeled. As noted above, if the structure calls for numerous electrical devices, the cost associated with wiring electrical devices is simply multiplied.

There exists, therefore, a need in the art for a quick connection device for operably coupling an electrical device to an electrical box during an installation process. The invention provides such a quick connection device. These and other advantages of the invention, as well as additional inventive features, will be apparent from the description of the invention provided herein.

### BRIEF SUMMARY OF THE INVENTION

The quick connection device is secured to, or incorporated into and integrally formed with, for example, an electrical box. Therefore, an electrical device is mounted to an electrical box in a relatively quick, easy and convenient manner.

In one aspect, a quick connection device having a body and a first resilient finger is provided. The first resilient finger extends from the body at a first pivot end and includes a first bolt engagement portion for engaging a threaded bolt. The first resilient finger applies a lateral force in a first direction traverse to an axis of rotation of the threaded bolt by bending as the threaded bolt is rotated.

In another aspect, a quick connection assembly for supporting an electrical device using at least one threaded bolt is provided. The quick connection assembly includes an electrical box configured to receive the electrical device and a quick connection device. The quick connection device is operably coupled to the electrical box and forms an opening between resilient fingers. The opening is configured to receive the at least one threaded bolt when pushed therethrough. The resilient fingers clamp the threaded bolt when the bolt is rotated.

In yet another aspect, a method of installing an electrical device in an electrical box using a threaded connecting member is provided. The method includes the steps of pushing the threaded connecting member between resilient fingers and rotating the threaded connecting member to increasingly clamp the threaded connecting member between the resilient fingers.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an exemplary embodiment of a quick connection device in accordance with the teachings of the present invention;

FIG. 2 is a perspective view of the quick connection device of FIG. 1 receiving a threaded bolt;

FIG. 3 is a perspective view of the threaded bolt disposed within the quick connection device of FIG. 1;

FIG. 4 is an exploded view of the quick connection device operably coupled to an electrical box and positioned to support an electrical device along with the threaded bolt;

FIG. 5 is a perspective view of the quick connection device the threaded bolt has been rotated and the resilient fingers have clamped down upon the threaded bolt;

FIG. 6A illustrates an alternative embodiment of a quick connection device in accordance with the teachings of the present invention, the quick connection device securing an electrical device to an electrical box; and

FIGS. 6B-6D include various views of the quick connection device of FIG. 6A.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

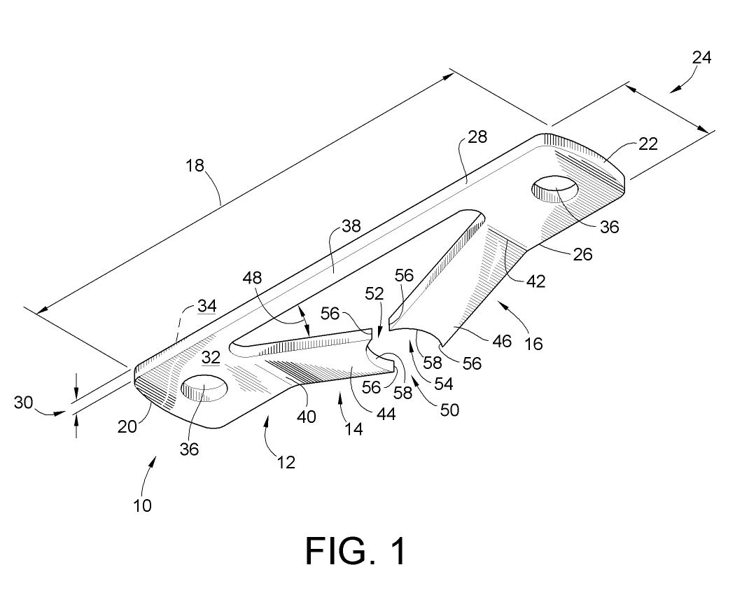

Referring to FIG. 1, a quick connection device 10 is illustrated. As will be more fully explained below, the quick connection device 10 is secured to, or incorporated into and integrally formed with, for example, an electrical box (a.k.a., electrical ring, junction box, electrical box cover, etc.). Therefore, an electrical device is mounted to an electrical box in a relatively quick, easy and convenient manner. As shown, the quick connection device 10 includes a body 12 and resilient fingers 14, 16. In the illustrated embodiment of FIG. 1, the resilient fingers 14, 16 generally oppose each other. However, the resilient fingers 14, 16 may have other suitable orientations.

The body 12 of the quick connection device 10 is generally flat and has a rectangular shape when viewed from above or below. The dimensions of the body 12 vary depending upon the particular application for which the quick connection device 10 is chosen. In the illustrated embodiment a length 18 of the body 12 is generally between about a half an inch and about three inches when measured from one end 20 of the body to another end 22. As shown in FIG. 1, the opposing ends 20, 22 of the body 12 are radiused or rounded.

The width 24 of the body, when measured from a front 26 of the body 12 to the back 28, is generally between about a quarter of an inch and about an inch. The thickness 30 of the body 12, when measured from a top surface 32 to a bottom surface 34 of the body, is approximately one sixteenth of an inch. Despite the above-noted ranges, the overall size and dimensions of the quick connection device 10 may be altered to suit particular applications.

In the illustrated embodiment of FIG. 1, the body 12 and the resilient fingers 14, 16 are unitarily formed with each other. Even so, in other embodiments the body 12 and the resilient fingers 14, 16 are separate and distinct components operably coupled together by, for example, a hinge. As shown, the quick connection device 10, including the body 12 and resilient fingers 14, 16, is formed from a spring steel. However, other construction materials are also suitably employed to form the quick connection device 10. If desired, the quick connection device 10 is coated, rust-proofed, painted or otherwise covered for aesthetic or functional purposes.

As shown in FIG. 1, the body 12 includes a coupling structure 36 proximate each of the ends 20, 22. The coupling structures 36 are employed to couple the quick connection device 10 to another device, assembly, or component as needed or desired. For example, the coupling structures 36 are used to secure the quick connection device to an electrical box or electrical box cover. Depending on their particular orientation and configuration, the coupling structures 36 are formed on and/or within the body 12.

In the illustrated embodiment, the coupling structures 36 are apertures passing from the top to bottom surface 32, 34 of the body 12. If the apertures are free of threads, a rivet, bolt and nut combination, or another connector may suitably secure the quick connection device 10 to another proximate device. If on the other hand the apertures are threaded or tapped, a screw, a threaded bolt without a nut, or another threaded member may be suitably used to couple the quick connection device 10 to another device. In one embodiment, the coupling structures 36 are simply flat portions of the body 12 suitable for accepting a weld or forming a welded connection.

In the illustrated embodiment, the body 12 also includes a connecting strip 38. The connecting strip 38 is laterally spaced apart from the resilient fingers 14, 16 and generally spans across the body 12 between the ends 20, 22. The connecting strip 38 is, in the illustrated embodiment, created when the resilient fingers are cut or otherwise formed out of a single workpiece. The connecting strip 38 is laterally spaced from the resilient fingers 14, 16 and holds opposing portions of the body 12 together.

The resilient fingers 14, 16 each include a pivot end 40, 42 and a free end 44, 46, respectively. Beginning proximate their respective pivot ends 40, 42, the resilient fingers 14, 16 each extend upwardly away from the back top surface 32 of the body 12. In other words, each resilient finger 14, 16 is canted relative to the body 12 and generally becomes further spaced apart from the body as the resilient finger 14, 16 progresses toward the free end 44, 46. In this arrangement and as shown in FIG. 1, the resilient fingers 14, 16 each generally form an acute angle 48 with connecting strip 38 of the body 12.

The free end 44, 46 of each of the resilient fingers 14, 16 is generally directed toward the free end 44, 46 of the resilient finger. As such, the free ends 44, 46 of the resilient fingers 14, 16 form an opening 50 between them. In the illustrated embodiment, the opening 50 has border that is not completely defined by structure. Indeed, as the resilient fingers 14, 16 are pivoted such that the free ends 44, 46 are drawn closer together or pushed further apart together, the opening 50 has either a periphery that becomes more or less defined, respectfully. If the free ends 44, 46 engage each other, the periphery of the opening becomes completely defined by the structure.

In the illustrated embodiment, each of the free ends 44, 46 includes bolt engagement portion in the form of a notch 52, 54 (a.k.a., detent, recess, etc.) formed between tips 56 of the free ends. Even so, in other embodiments only one, or perhaps neither, of the free ends 44, 46 is formed with a notch 52, 54. In FIG. 1, each of the notches 52, 54 generally opens up toward the other notch. Therefore, the notches 52, 54 collectively form the opening 50 disposed between the resilient fingers 14, 16.

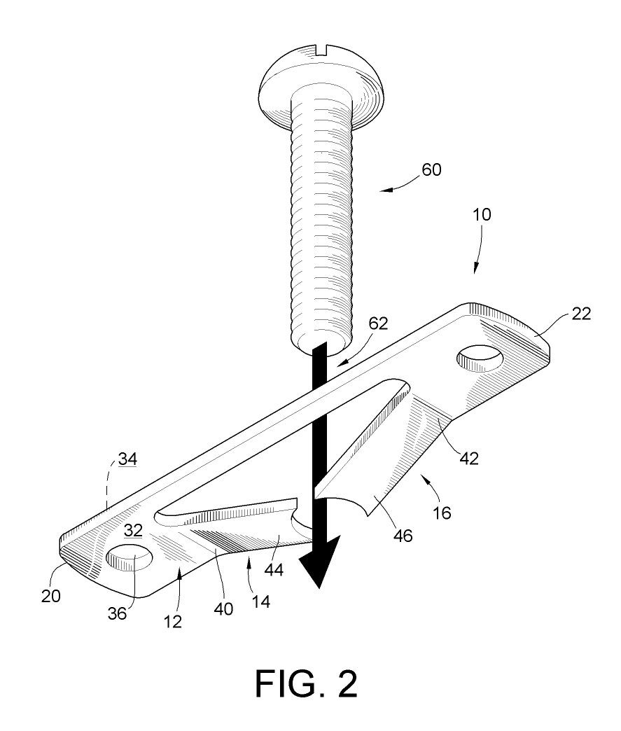

While other shapes are possible and contemplated, each of the notches 52, 54 in FIG. 1 has a concave, semi-circular periphery 58. As such, when the notches 52, 54 are collectively viewed from below in FIG. 1, the opening 50 is generally round or circular in shape. With this configuration, the opening 50 formed between the free ends 44, 46 of the resilient fingers 14, 16 is particularly well suited to accommodate a generally cylindrical connecting member such as, for example, a threaded bolt 60, which is depicted in FIG. 2.

Because the resilient fingers 14, 16 are flexible and able to pivot about the pivot ends 40, 42, the threaded bolt 60 (or other type of connector) is able to be pushed through the opening 50 in the direction generally indicated by arrow 62. As the arrow 62 indicates, the threaded bolt 60 passes through the quick connection device 10 from the back surface 34 of the body 12 to the front 32 as shown in FIG. 2. When the threaded bolt 60 is pushed through in this manner, the free ends 44, 46 of the resilient fingers 14, 16 are generally biased away from each other to expand the size of the opening 50.

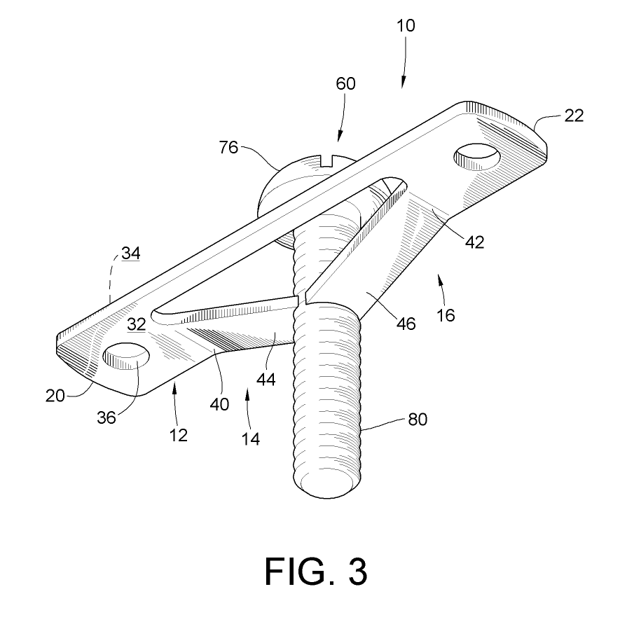

Because the quick connection device 10 is generally made from a resilient material such as spring steel, the free ends 44, 46 of the resilient fingers 14, 16 are naturally biased back toward the front surface 32 of the body 12. Therefore, the free ends 44, 46 clamp down upon the threaded bolt 60 as shown in FIG. 3. After the threaded bolt 60 has been pushed between the resilient fingers 14, 16, the threaded bolt is held safely in place.

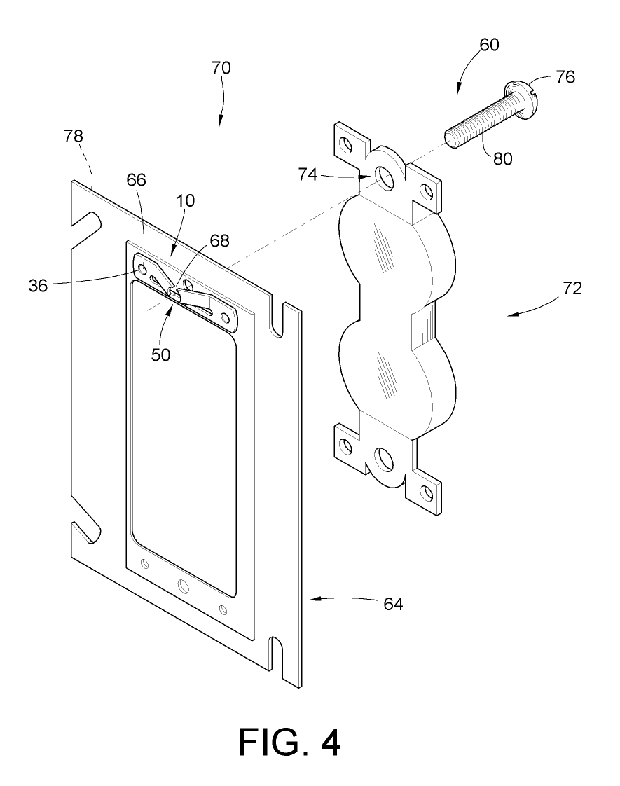

In one particularly useful application, as depicted in FIG. 4, the quick connection device 10 is coupled to an electrical box 64. While the quick connection device 10 may be simply integrated into the electrical box 10 in one embodiment, as shown in FIG. 4 the quick connection device 10 has been secured to the electrical box using rivets 66 passing through the coupling structures 36. When attached in this manner, a central aperture 68 in the electrical box 64 is generally aligned with the opening 50 in the quick switch connection device 10.

Despite being secured to the electrical box 64 in the illustrated embodiment of FIG. 4, the quick connection device 10 may also be suitably mounted to other electrical components such as, for example, an electrical ring, junction box, electrical box cover, or other device (not shown). In that regard, the quick connection device 10 is configured to be easily retro-fit to, or integrated within, existing electrical parts and accessories.

When joined as shown in FIG. 4, the quick connection device 10 and the electrical box 64 collectively form a quick connection assembly 70. The quick connection assembly 70 is utilized to support an electrical device 72 such as, for example, an electrical receptacle, electrical outlet, plug-in, phone jack, network cable jack, or other electrical coupling or connector used in the industry. Using the quick connection assembly 70, securing the electrical device 72 to the quick connection assembly 70 is a quick, easy and convenient process, the details of which are noted below.

When the quick connection assembly 70 benefiting from the quick connection device 10 is called into service, the electrical device 72 is generally maneuvered close to the quick connection assembly. When the aperture 74 in the electrical device 72 is aligned with the aperture 68 in the electrical box 64, the threaded bolt 60 shown in FIG. 4 is pushed through the resilient fingers 14, 16 (see FIGS. 2 and 3).

The electrician or other user is generally able to thrust the threaded bolt between the resilient fingers 14, 16 using, for example, a thumb or finger. At this time, the opening 50 formed between the resilient fingers 14, 16 may expand to receive the threaded bolt 60. Typically, the threaded bolt 60 is forced into the electrical box 64 until the head 76 of the threaded bolt 60 engages or comes into close proximity with the front side 78 of the electrical box. Because a portion of the threaded bolt 60 is axially inserted into the electrical box 64 instead of being rotatably driven, a substantial amount of installation time is saved.

After having been forced between the resilient fingers 14, 16, the threaded bolt 60 is generally captured by the quick connection device 10. Thereafter, the threaded bolt is rotated. The rotational force is supplied to the threaded bolt 60 by, for example, a tool such as a cordless drill or screwdriver. When the electrician or user wielding the tool causes the threaded bolt 60 to rotate in a particular direction, the free ends 44, 46 of the resilient fingers 14, 16 engage with the threads 80 on the threaded bolt.

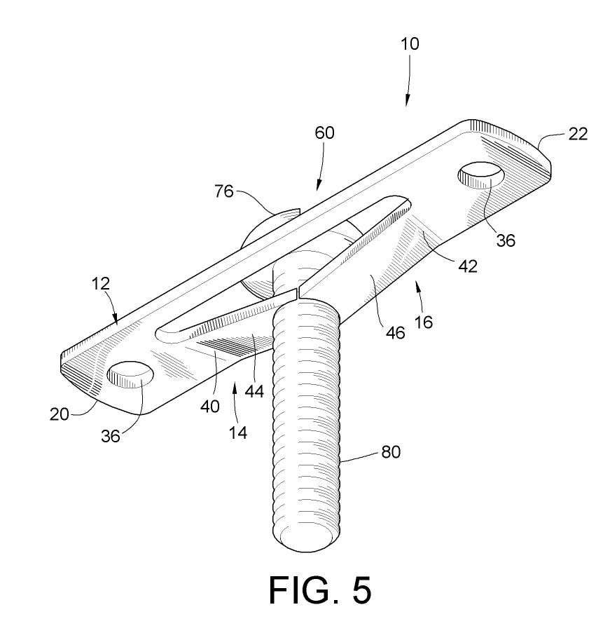

As the threaded bolt 60 is rotated, the free ends 44, 46 of the resilient fingers 14, 16 are pulled toward each other and drawn toward the bottom surface 32 of the quick connection device 10 as shown in FIG. 5. This causes the opening 50 between the resilient fingers 14, 16 to reduce in size or constrict and, therefore, the resilient fingers to clamp down upon the threaded bolt 60. With enough rotation, the threaded bolt 60 is sufficiently secured between the resilient fingers 14, 16. As such, the electrical device 72 of FIG. 4 is securely mounted to the electrical box 64.

Because many of the threads 80 were pushed past the free ends 44, 46 of the resilient fingers 14, 16 (as shown in FIG. 3), the amount of rotation required to tighten and secure the threaded bolt 60 within the quick connection device 10 (as shown in FIG. 5) is not substantial or excessive. Therefore, tightening the threaded bolt 60 within the quick connection device 10 is no longer such a burdensome and time consuming task. Indeed, the threaded bolt 60 is quickly pushed between the resilient fingers 14, 16, rotated a few turns instead of numerous turns, and then held in place.

Despite a pair of resilient fingers 14, 16 having been depicted in FIG. 1, a greater number (e.g., three, four, etc.) of resilient fingers may also be suitably used to engage and hold the threaded bolt 60. For example, several resilient fingers may be oriented in a generally circular pattern such that the resilient fingers collectively engage and clamp down upon the threaded bolt 60.

From the foregoing, those skilled in the art will recognize that using the quick connection device 10 to secure electrical devices 72 will save time because only a portion of the threads 80 on the threaded bolt 60 need to be rotated past the free ends 44, 46 of the resilient fingers 14, 16 for the electrical device to be secured in place. When numerous electrical devices 72 must be installed in a structure, saving time on each electrical device decreases the overall time and expense of electrical installation work. As a result, the cost of completing the overall structure is reduced.

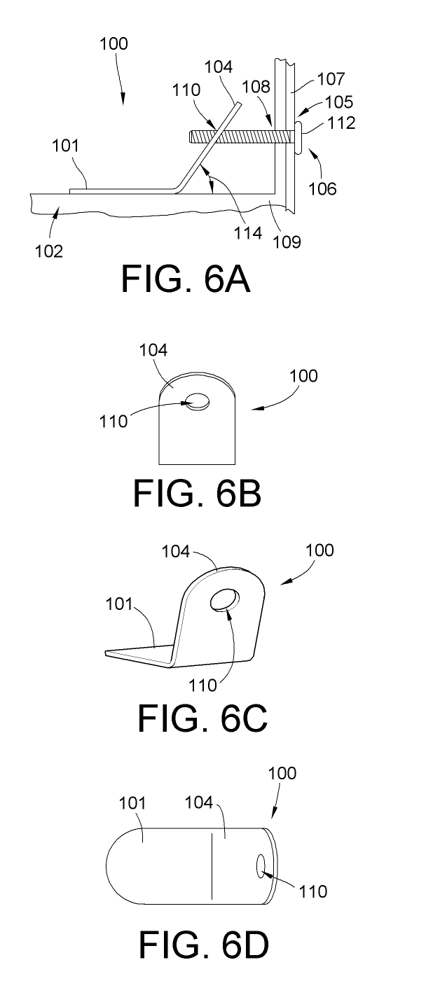

In FIGS. 6A-6C, another embodiment of a quick connection device 100 is depicted. The quick connection device 100 includes a body 101 and a single resilient finger 104. The body 101 is operably coupled to an electrical box 102. In this embodiment, a threaded bolt 106 is pushed through an aperture 105 in an electrical device 107, through an aperture 108 in the electrical box 102, and then through an aperture 110 in the resilient finger 104. A side wall of the aperture 110 in the resilient finger 104 forms a bolt engagement portion.

As the threaded bolt 106 is rotated, the resilient finger 104 pivots generally toward the head 112 of the threaded member 106 and reduces the angle 114 between the resilient finger and the bottom portion 109 of the electrical box 102. As such, the lateral force exerted upon the threaded bolt 106 by the resilient finger 104 increases and the threaded bolt is able to suitably secure the electrical device 107 to the electrical box.

In the embodiment of FIGS. 6A-6D, because the threaded bolt 106 is generally pushed through the opening 110 in the resilient finger 104 and rotated only a few times to tighten the threaded bolt, the process of securing the electrical device 107 to the electrical box 102 is a relatively quick and easy process.

From the foregoing, those skilled in the art will recognize that using the quick connection device 10 to secure electrical devices 72 will save time because only a portion of the threads 80 on the threaded bolt 60 need to be rotated past the free ends 44, 46 of the resilient fingers 14, 16 for the electrical device to be secured in place. When numerous electrical devices 72 must be installed in a structure, saving time on each electrical device decreases the overall time and expense of electrical installation work. As a result, the cost of completing the overall structure is reduced.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A quick connection device, comprising:
a body;
a first resilient finger extending from the body at a first pivot end, the first resilient finger including a first bolt engagement portion for engaging a threaded bolt, the first resilient finger applying a lateral force in a first direction traverse to an axis of rotation of the threaded bolt by pivoting as the threaded bolt is rotated.

2. The quick connection device of claim 1, wherein the first bolt engagement portion is a side wall of an aperture passing through the resilient finger.

3. The quick connection device of claim 1, wherein the first bolt engagement portion is a notch formed on a first free end of the first resilient finger, and wherein the quick connection device further comprises a second resilient finger extending from the body at a second pivot end, the second resilient finger including a second bolt engagement portion being a second free end having a second notch, the first and second notches directed toward each other and collectively forming an opening, the opening configured to receive the threaded bolt pushed therethrough, the second bolt engagement portion applying a second lateral force in a second direction transverse to the axis of rotation of the threaded bolt, and generally opposing the lateral force in the first direction, such that when the bolt is rotated the first and second resilient fingers clamp the threaded bolt.

4. The quick connection device of claim 3, wherein a size of the opening is reduced when the threaded bolt is rotated.

5. The quick connection device of claim 3, wherein the body and the first and second resilient fingers are unitarily formed from a spring steel.

6. The quick connection device of claim 3, wherein at least one of the first and second notches is semi-circular.

7. The quick connection device of claim 3, wherein the first and second notches are both semi-circular such that the opening is generally circular.

8. The quick connection device of claim 3, wherein the first and second free ends are configured to pivot about the first and second pivot ends, respectively, when the bolt is rotated.

9. The quick connection device of claim 3, wherein the body includes a coupling structure, the coupling structure employed to suitably mount the quick connection device to an electrical box.

10. The quick connection device of claim 9, wherein the coupling structure is an aperture configured to receive a connector.

11. The quick connection device of claim 3, wherein the body includes a connecting strip, the connecting strip unitarily coupling the first and second resilient fingers, the first and second resilient fingers laterally spaced apart from the connecting strip.

12. The quick connection device of claim 11, wherein the connecting strip is disposed vertically below the first and second free ends.

13. The quick connection device of claim 3, wherein the first and second resilient fingers cinch down upon the threaded bolt from opposing directions when the threaded bolt is rotated.

14. A quick connection assembly for supporting an electrical device using at least one threaded bolt, comprising:
an electrical box configured to receive the electrical device; and
a quick connection device operably coupled to the electrical box, the quick connection device forming an opening between resilient fingers, the opening configured to receive the at least one threaded bolt when pushed therethrough, the resilient fingers clamp the threaded bolt when the bolt is rotated.

15. The quick connection assembly of claim 14, wherein the quick connection device is operably coupled to a rear surface of the electrical box.

16. The quick connection assembly of claim 14, wherein the electrical box and the quick connection device are unitarily formed with each other.

17. The quick connection assembly of claim 14, wherein the quick connection device is secured to the electrical box by a connection selected from the group consisting of a weld, a rivet, a nut and bolt combination, and a screw.

18. A method of installing an electrical device in an electrical box using a threaded connecting member, the method comprising the steps of:
pushing the threaded connecting member between resilient fingers; and
rotating the threaded connecting member to increasingly clamp the threaded connecting member between the resilient fingers.

19. The method of claim 18, wherein the method further comprises the step of drawing the resilient fingers toward each other.

20. The method of claim 18, wherein the method further comprises the step of drawing the resilient fingers toward at least one of the electrical box and the electrical device.

21. The method of claim 18, wherein the method further comprises the step of reducing a size of an opening formed between the resilient fingers during the rotating step.
